(19) United States
(12) Patent Application Publication
(10) Pub. No.: US 2025/0352912 A1
(43) Pub. Date: Nov. 20, 2025

(54) INFORMATION PROCESSING METHOD, DEVICE, AND STORAGE MEDIUM

(71) Applicant: NETEASE (HANGZHOU) NETWORK CO.,LTD., Hangzhou (CN)

(72) Inventor: Xing XU, Hangzhou (CN)

(73) Assignee: NETEASE (HANGZHOU) NETWORK CO., LTD., Hangzhou (CN)

(21) Appl. No.: 17/628,927

(22) Filed: Jan. 21, 2022

Related U.S. Application Data
(63) Continuation of application No. PCT/CN2019/121054, filed on Nov. 26, 2019.

(30) Foreign Application Priority Data
Jul. 23, 2019 (CN) 201910665079.2

(51) Int. Cl. A63F 13/75; A63F 13/52

(52) U.S. Cl. CPC A63F 13/75; A63F 13/52

(57) ABSTRACT

Embodiments of the present disclosure provide an information processing method, a device, and a storage medium. The method comprises: a game server receiving an operation message sent by a first client, wherein the operation message carries position information corresponding to a start point and a destination point of an attack operation, and the first client has triggered the attack operation; the game server sending to at least one second client the position information corresponding to the start point and the destination point of the attack operation, determining, by the at least one second client, whether an obstacle exists between the start point and the destination point of the attack operation, and sending a determination result to the game server, the second client being a participant of the same game round as the first client; and the game server deciding, according to the determination result, whether the first client has used a plugin program when executing the attack operation. Since the operation of determining whether an obstacle exists between the start point and the destination point of the attack operation is executed by the second client, the invention reduces overheads of the server.

### CROSS-REFERENCE

The present application is a continuation application of PCT Application No. PCT/CN2019/121054, entitled “INFORMATION PROCESSING METHOD, DEVICE, AND STORAGE MEDIUM” filed on Nov. 26, 2019, which is based on and claims priority to the Chinese Patent Application NO. 201910665079.2, entitled “INFORMATION PROCESSING METHOD, DEVICE, AND STORAGE MEDIUM”, filed on Jul. 23, 2019, the entire contents of both of which are hereby incorporated by reference.

### TECHNICAL FIELD

Embodiments of the present disclosure relate to online games, and in particular, to an information processing method, device, and storage medium.

### BACKGROUND

In online games, a hacking tool generally refers to a cheating program that seeks benefits for players by modifying the online games, that is to say, the cheating program is made by changing some programs of software using computer technologies with respect to the software. For example, under normal circumstances, when there is an obstacle between virtual characters controlled by a player A and a player B, the two virtual characters are invisible to each other and cannot attack each other: but when the player A uses the hacking tool which has a function of removing all obstacles, the virtual character controlled by the player A can see and attack the virtual character corresponding to the player B. Therefore, in order to ensure fairness of the online games, it is necessary to prevent the use of the hacking tools in practical applications.

It should be noted that the information disclosed in the Background section above is only for enhancing the understanding of the background of the present disclosure, and thus may include information that does not constitute prior art known to those of ordinary skill in the art.

### SUMMARY

Embodiments of the present disclosure provide an information processing method, device, and storage medium.

In a first aspect, the embodiments of the present disclosure provide an information processing method, including: receiving, by a game server, an operation message sent by a first client, wherein the operation message carries location information corresponding to a starting point and an ending point of an attack operation, and the attack operation is triggered by the first client: sending, by the game server, the location information corresponding to the starting point and the ending point of the attack operation to at least one second client, to cause the at least one second client to determine whether there is an obstacle between the starting point and the ending point of the attack operation and send a determination result to the game server, wherein the first client and the second client are participating in a same game round; and deciding, by the game server according to the determination result, whether the first client uses a hacking tool when performing the attack operation.

In a second aspect, the embodiments of the present disclosure provide an information processing method, including: sending, by a first client, an operation message to a game server, wherein the operation message carries location information corresponding to a starting point and an ending point of an attack operation, and the attack operation is triggered by the first client, the location information corresponding to the starting point and the ending point of the attack operation being sent to at least one second client by the game server to cause the at least one second client to determine whether there is an obstacle between the starting point and the ending point of the attack operation and send a determination result to the game server, to cause the game server to decide, according to the determination result, whether the first client uses a hacking tool when performing the attack operation, wherein the first client and the second client are participating in a same game round.

In a third aspect, the embodiments of the present disclosure provide an information processing method, including: receiving, by a second client, location information corresponding to a starting point and an ending point of an attack operation sent by a game server, wherein the location information corresponding to the starting point and the ending point of the attack operation is sent to the game server by a first client, and the first client and the second client are participating in a same game round: determining, by the second client, whether there is an obstacle between the starting point and the ending point of the attack operation according to the location information corresponding to the starting point and the ending point of the attack operation; and sending, by the second client, a determination result to the game server, to cause the game server to decide, according to the determination result, whether the first client uses a hacking tool when performing the attack operation.

According to a fourth aspect, the embodiments of the present disclosure provide an information processing device applied to a game server. The device includes: a receiving module, configured to receive an operation message sent by a first client, wherein the operation message carries location information corresponding to a starting point and an ending point of an attack operation, and the attack operation is triggered by the first client: a sending module, configured to send the location information corresponding to the starting point and the ending point of the attack operation to at least one second client to cause the at least one second client to determine whether there is an obstacle between the starting point and the ending point of the attack operation and send a determination result to the game server, wherein the first client and the second client are participating in a same game round; and a processing module, configured to decide whether the first client uses a hacking tool when performing the attack operation according to the determination result.

According to a fifth aspect, the embodiments of the present disclosure provide an information processing device applied to a first client. The device includes: a sending module, configured to send an operation message to a game server, wherein the operation message carries location information corresponding to a starting point and an ending point of an attack operation, and the attack operation is triggered by the first client, the location information corresponding to the starting point and the ending point of the attack operation being sent to at least one second client by the game server, to cause the at least one second client to determine whether there is an obstacle between the starting point and the ending point of the attack operation and send a determination result to the game server, to cause the game server to decide, according to the determination result, whether the first client uses a hacking tool when performing the attack operation, wherein the first client and the second client are participating in a same game round.

In a sixth aspect, the embodiments of the present disclosure provide an information processing device applied to a second client. The device includes: a receiving module, configured to receive location information corresponding to a starting point and an ending point of an attack operation sent by a game server, wherein the location information corresponding to the starting point and the ending point of the attack operation is sent to the game server by a first client, and the first client and the second client are participating in a same game round: a processing module, configured to determine whether there is an obstacle between the starting point and the ending point of the attack operation according to the location information corresponding to the starting point and the ending point of the attack operation; and a sending module, configured to send a determination result to the game server to cause the game server to decide, according to the determination result, whether the first client uses a hacking tool when performing the attack operation.

In a seventh aspect, the embodiments of the present disclosure provide an information processing device including: a memory for storing program instructions and a processor: wherein the program instructions, when being executed by the processor, cause the information processing device to implement the method according to the first aspect.

In an eighth aspect, the embodiments of the present disclosure provide a computer-readable storage medium having stored thereon a computer program which, when being executed by a processor, implements the method according to the first aspect.

It should be noted that the above general description and the following detailed description are merely exemplary and explanatory and should not be construed as limiting of the disclosure.

### BRIEF DESCRIPTION OF THE DRAWINGS

In order to explain embodiments of the present disclosure or technical solutions in the prior art more clearly, drawings that need to be used in the description of the embodiments or the prior art will be briefly introduced below. It is apparent that the drawings in the following description show only some of the embodiments of the present disclosure, and other drawings may be obtained by those skilled in the art from these drawings.

FIG. 1 is a signaling interaction diagram of an information processing method provided by an embodiment of the present disclosure;

FIG. 2 is a signaling interaction diagram of an information processing method provided by another embodiment of the present disclosure:

FIG. 3 is a schematic structural diagram of an information processing device provided by an embodiment of the present disclosure:

FIG. 4 is a schematic structural diagram of an information processing device provided by another embodiment of the present disclosure:

FIG. 5 is a schematic structural diagram of an information processing device provided by still another embodiment of the present disclosure; and

FIG. 6 is a schematic structural diagram of an information processing device provided by still another embodiment of the present disclosure.

### DETAILED DESCRIPTION

To make objectives, technical solutions, and advantages of embodiments of the present disclosure more clear, the technical solutions in the embodiments of the present disclosure will be described below in conjunction with the drawings in the embodiments of the present disclosure. Obviously, the described embodiments are part, but not all, of the embodiments of the present disclosure. Based on the embodiments in the present disclosure, all other embodiments obtained by those of ordinary skill in the art without making creative efforts fall within the protection scope of the present disclosure.

It should be noted that the terms “first” and “second” in respective parts of the embodiments of the present disclosure and the drawings are used for distinguishing similar objects, and do not have to be used for describing a specific order or sequence. It should be understood that the data used in this way are interchangeable under appropriate circumstances so that the embodiments of the present disclosure described herein can be implemented in an order other than those illustrated or described herein. In addition, the terms “including” and “having” and any variations thereof are intended to cover non-exclusive inclusions, for example, processes, methods, systems, products or devices that contain a series of steps or units need not be limited to those clearly listed steps or units, but may include other steps or units not explicitly listed or inherent to these processes, methods, products, or devices.

The method flowcharts involved in the following embodiments of the present disclosure are only exemplary and descriptive, and it is not necessary to include all contents and steps, nor to be executed in the order described. For example, some of the steps can be divided, and some of the steps can be combined or partially combined. Therefore, an actual execution order can be changed according to an actual situation.

Functional modules in the block diagrams involved in the following embodiments of the present disclosure are merely functional entities and do not necessarily correspond to physically separate entities. That is, these functional entities may be implemented in software, or implemented in one or more hardware modules or integrated circuits, or implemented in different networks and/or processors and/or microcontrollers.

An existing method for preventing the use of a hacking tool is to detect whether a client uses the hacking tool by a game server. Specifically, in the above example, when the player A attacks the player B, a client where the player A is located sends attack information to the game server, and the game server determines whether the player A can attack the player B by using a physical map it stores. If so, it indicates that the client where the player A is located uses the hacking tool when performing the attack: if not, it means that the client where the player A is located does not use the hacking tool when performing the attack. A disadvantage of the related art is that each time the attack occurs, the game server needs to use the physical map stored by itself to determine whether the player A can attack the player B, which leads to excessive load on the game server.

An information processing method, device, and storage medium provided by the embodiments of the present disclosure will be described below in conjunction with multiple instances.

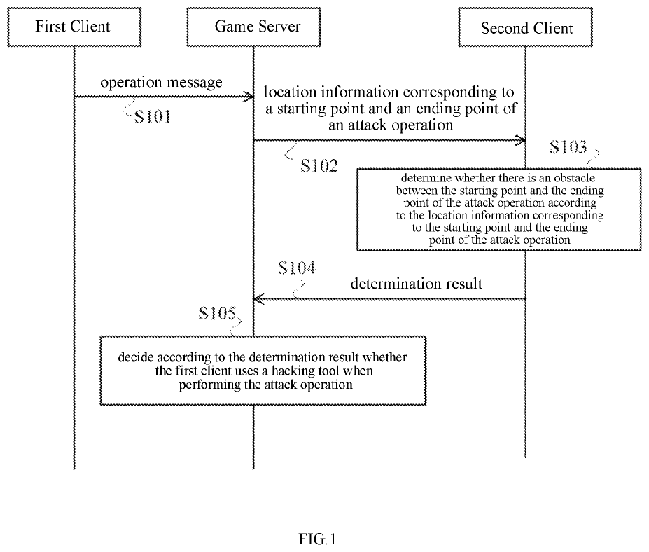

FIG. 1 is a signaling interaction diagram of an information processing method provided by an embodiment of the present disclosure. The information processing method can be implemented by a processing device, such as a processor, of a game server and a client (including a first client and a second client, where the second client and the first client participate in a same game round) executing corresponding software codes, or can also be implemented by the processing device of the game server and the client executing the corresponding software codes in conjunction with other hardware entities. The client is, for example, a device that can run a game, such as a mobile phone or a tablet. The game server may be a server, or a server cluster composed of several servers, a cloud computing service center, or the like.

It should be noted that the first client and the second client in the embodiments of the present disclosure are relative. Exemplarily, the player A, player B and player C participate in a certain game. When the player A attacks the player B, the client where the player A is located is the first client, and the clients where the player B and player C are located are the second clients; and when the player C attacks the player A, the client where the player C is located is the first client, and the clients where the player A and player B are located are the second clients. The number of second clients is not limited in the embodiments of the present disclosure, and may be specifically determined according to a type of the game or the number of clients participating in the game.

As shown in FIG. 1, the information processing method shown in this embodiment includes the following steps.

In S101, the game server receives an operation message sent by a first client.

The operation message carries location information corresponding to a starting point and an ending point of an attack operation, and the first client is a client that triggers the attack operation

For example, during the game, when the player A attacks the player B, the first client where the player A is located sends the operation message to the game server. The location information corresponding to the starting point of the attack operation can be, for example, a three-dimensional coordinate in a 3D game scene, including coordinate values of three coordinate axes x, y and z, which represents a point in space; and the location information corresponding to the ending point of the attack operation is also a point in space, that is, a position that is attacked on the player B.

In S102, the game server sends the location information corresponding to the starting point and the ending point of the attack operation to at least one second client.

Correspondingly, the second client receives the location information corresponding to the starting point and the ending point of the attack operation sent by the game server.

In S103, the second client determines whether there is an obstacle between the starting point and the ending point of the attack operation according to the location information corresponding to the starting point and the ending point of the attack operation.

Specifically, the second client performs simulation calculation based on the location information corresponding to the starting point and the ending point of the attack operation to determine whether there is the obstacle between the starting point and the ending point of the attack operation. If the second client determines that there is the obstacle between the starting point and the ending point of the attack operation, it means that the current attack operation is illegal, because “shooting through the wall” is an operation against common sense in the game world, that is, this attack operation should cause no damage to the player B; and if the second client determines that there is no obstacle between the starting point and the ending point of the attack operation, it means that this attack is legal, that is, the attack operation should cause damage to the player B.

In S104, the second client sends the determination result to the game server.

It can be understood that the number of determination results is less than or equal to the number of second clients in this game. For example, regardless of the determination result determined by the second client is that there is the obstacle and/or no obstacle between the starting point and the ending point of the attack operation, the determination result is sent to the game server: or, only when the second client determines that there is the obstacle between the starting point and the ending point of the attack operation, the determination result is sent to the game server: or, only when the second client determines that there is no obstacle between the starting point and the ending point of the attack operation, the determination result is sent to the game server, and so on. The specific settings can be set according to requirements, and this embodiment is not limited thereto.

Correspondingly, the game server receives the determination result sent by the second client.

In S105, the game server decides based on the determination result whether the first client uses a hacking tool when performing the attack operation.

Since the determination result may have different functions as described in the S104, there may be multiple implementations in this step, which will be described by way of examples below:

In a first implementation, this step may include that the game server counts the number of the second clients that have sent the determination result that there is the obstacle between the starting point and the ending point of the attack operation, and when the number is greater than or equal to a threshold, it is decided that the first client uses the hacking tool when performing the attack operation: otherwise, it is decided that the first client does not use the hacking tool when performing the attack operation. For example, there are 10 second clients participating in the same game round, and the game server sends the corresponding information of the attack operation to the 10 second clients. When five of the second clients feedback the determination result that there is the obstacle between the starting point and the ending point of the attack operation and the threshold is 5, it can be decided that the first client uses the hacking tool when performing the attack operation. In the case where the threshold is still 5 and the game server only receives the determination results feedback by two second clients that there is the obstacle between the starting point and the ending point of the attack operation, it is decided based on the small number of samples that the first client does not use the hacking tool when performing the attack operation.

Those skilled in the art can understand that the determination result in this implementation is used for indicating that there is the obstacle between the starting point and the ending point of the attack operation. That is to say, the second client only sends the determination result to the game server when determining that there is the obstacle between the starting point and the ending point of the attack operation, otherwise it does not send it.

In a second implementation manner, this step may include that the game server counts the determination results sent by at least one second client, and decides whether the first client uses the hacking tool when performing the attack operation according to a statistical result. Those skilled in the art can understand that the determination result in this implementation can be used for indicating there is an obstacle or no obstacle between the starting point and the ending point of the attack operation.

Specifically, in this embodiment, if the second client only sends the determination result to the game server when determining there is the obstacle between the starting point and the ending point of the attack operation, when the number of determination results is greater than or equal to a first threshold, the game server decides that the first client uses the hacking tool when performing the attack operation: otherwise, it decides that the first client does not use the hacking tool when performing the attack operation.

Or, if the second client only sends the determination result to the game server when determining there is no obstacle between the starting point and the ending point of the attack operation, when the number of determination results is greater than or equal to a second threshold, the game server decides that the first client does not use the hacking tool when performing the attack operation, otherwise, it decides that the first client uses the hacking tool when performing the attack operation.

Or, regardless of the determination result sent by the second client is that there is the obstacle or no obstacle between the starting point and the ending point of the attack operation, both kinds of determination results are sent to the game server, and the game server counts the number of the two kinds of determination results, that is, the determination result that there is the obstacle and the determination result that there is no obstacle, separately. When the number of the determination results that there is the obstacle is greater than the number of determination results that there is no obstacle, the game server decides that the first client uses the hacking tool when performing the attack operation, otherwise, it decides that the first client does not use the hacking tool when performing the attack operation, and so on. The above threshold, the first threshold and the second threshold may be the same or different, which can be set according to actual needs.

According to the embodiments of the present disclosure, the game server receives the operation message sent by the first client, and the operation message carries the location information corresponding to the starting point and the ending point of the attack operation, where the first client is a client that triggers the attack operation. The game server then sends the location information corresponding to the starting point and the ending point of the attack operation to the at least one second client, and the at least one second client determines whether there is the obstacle between the starting point and the ending point of the attack operation and sends a determination result to the game server, where the second client is a client participating in a same game round as the first client. Finally, the game server decides whether the first client uses a hacking tool when performing the attack operation according to the determination result. Since the operation of determining whether there is the obstacle between the starting point and the ending point of the attack operation is performed by the second client, the overhead of the server can be reduced.

As for the threshold, it can be understood that the second client determines whether there is the obstacle between the starting point and the ending point of the attack operation according to the location information corresponding to the starting point and the ending point of the attack operation, that is, determines whether the current attack operation is valid, which is equivalent to the second client voting on whether the current attack operation is valid. The game server decides whether the first client uses the hacking tool when performing the attack operation according to a voting result (determination result) of the second client. Exemplarily, each time the game server receives one determination result reported by one second client, an error counter is incremented by one. An initial value of the error counter is 0, which is used for counting the number of the second clients sending the determination result, and the determination result is used for indicating that there is the obstacle between the starting point and the ending point of the attack operation.

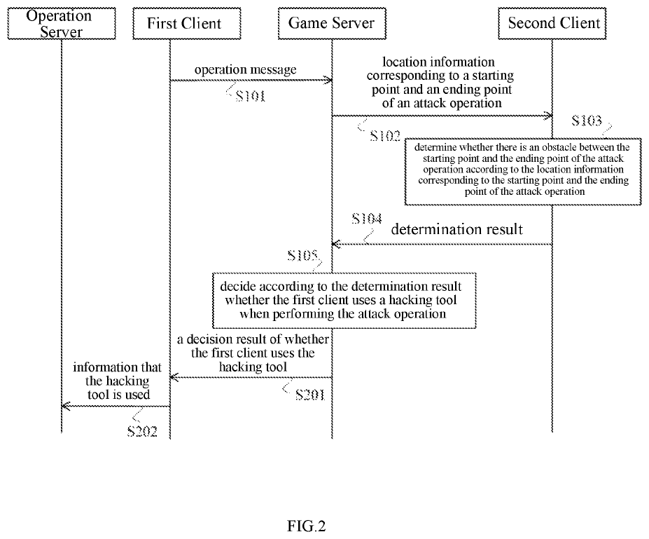

FIG. 2 is a signaling interaction diagram of an information processing method provided by another embodiment of the present disclosure. As shown in FIG. 2, on the basis of the flow shown in FIG. 1, after the game server decides whether the first client uses the hacking tool when performing the attack operation according to the determination result in S105, the information processing method can further include:

in S201, the game server sends a decision result of whether the first client uses the hacking tool to the first client.

Correspondingly, the first client receives the decision result of whether the first client uses the hacking tool sent by the game server.

If it is decided that the first client uses the hacking tool, S202 is performed; otherwise, the process ends.

In S202, the first client sends information that the hacking tool has been used to an operation server.

Optionally, when it is decided that the first client has used the hacking tool, the first client takes a screenshot to keep an evidence, and sends the information that it has used the hacking tool to the operation server, so that the operation server performs operation management, for example, blocking a game account, forbidding the game account to match with clients where other players are located, or the like.

In this embodiment, when it is decided that the first client has used the hacking tool, the first client sends the information that it has used the hacking tool to the operation server, so that the operation server performs operation management, thereby implementing process for the hacking tool in the game to ensure the fairness of the game.

In the above embodiment, from the perspective of the first client, the steps performed by the first client include that the first client sends the operation message to the game server, where the operation message carries the location information corresponding to the starting point and the ending point of the attack operation, and the attack operation is triggered by the first client, the location information corresponding to the starting point and the ending point of the attack operation being sent to the at least one second client by the game server, to cause the at least one second client to determine whether there is the obstacle between the starting point and the ending point of the attack operation and send a determination result to the game server, so that the game server decides according to the determination result whether the first client uses a hacking tool when performing the attack operation, where the first client and the second client are participating in a same game round.

Optionally; after the first client sends the operation message to the game server, the information processing method may further include that the first client receives the determination result of whether the first client uses the hacking tool sent by the game server: if it is determined that the first client uses the hacking tool, the first client sends the information that the hacking tool has been used to the operation server.

The first client in this embodiment described from the perspective of the first client may be configured to perform the technical solutions performed by the first client in each of the corresponding method embodiments. The implementation principles and technical effects are similar, which will not be repeated here.

In addition, from the perspective of the second client, the steps performed by the second client include that the second client receives the location information corresponding to the starting point and the ending point of the attack operation sent by the game server, where the location information corresponding to the starting point and the ending point of the attack operation is sent by the first client the game server, the attack operation is triggered by the first client, and the first client and the second client are participating in a same game round: the second client determines whether there is the obstacle between the starting point and the ending point of the attack operation according to the location information corresponding to the starting point and the ending point of the attack operation; and the second client sends the determination result to the game server, so that the game server decides according to the determination result whether the first client uses the hacking tool when performing the attack operation.

The second client in this embodiment described from the perspective of the second client may be configured to perform the technical solutions performed by the second client in each of the corresponding method embodiments. The implementation principles and technical effects are similar, which will not be repeated here.

The device embodiments of the present disclosure are described below; which can be used for performing the above-described method embodiments of the present disclosure, and the implementation principles and technical effects thereof are similar.

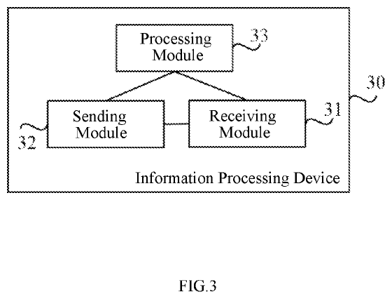

FIG. 3 is a schematic structural diagram of an information processing device according to an embodiment of the present disclosure. The embodiments of the present disclosure provide an information processing device, which is applied to a game server. As shown in FIG. 3, the information processing device 30 of this embodiment may include: a receiving module 31, a sending module 32, and a processing module 33.

The receiving module 31 is configured to receive an operation message sent by a first client, where the operation message carries location information corresponding to a starting point and an ending point of an attack operation, and the attack operation is triggered by the first client.

The sending module 32 is configured to send the location information corresponding to the starting point and the ending point of the attack operation to at least one second client, to cause the at least one second client to determine whether there is an obstacle between the starting point and the ending point of the attack operation and send a determination result to the game server, where the first client and the second client are participating in a same game round.

The processing module 33 is configured to decide whether the first client uses a hacking tool when performing the attack operation according to the determination result.

Optionally, the sending module 32 may be further configured to send a decision result of whether the first client uses the hacking tool to the first client. If it is decided that the first client uses the hacking tool, the first client sends information that it has used the hacking tool to an operation server.

In some embodiments, the processing module 33 may be specifically configured to: count the number of the second clients that have sent the determination result that there is the obstacle between the starting point and the ending point of the attack operation, and when the number of the second clients is greater than or equal to a threshold, decide that the first client uses the hacking tool when performing the attack operation, otherwise, decide that the first client does not use the hacking tool when performing the attack operation.

Alternatively, the processing module 33 may be specifically configured to: count the determination results sent by the at least one second client, and decide whether the first client uses the hacking tool when performing the attack operation according to the counting result.

Further, the threshold may also be carried in the operation message as described above.

The information processing device described in this embodiment can be configured to perform the technical solutions performed by the game server in the above corresponding method embodiments, the implementation principles and technical effects thereof are similar, and for the functions of the individual modules, reference can be made to the corresponding descriptions in the method embodiments, which will not be repeated here.

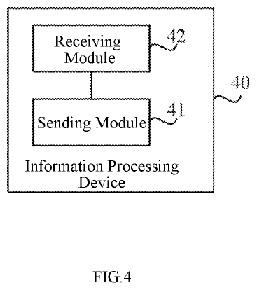

FIG. 4 is a schematic structural diagram of an information processing device according to another embodiment of the present disclosure. The embodiments of the present disclosure provide an information processing device, which is applied to a first client. As shown in FIG. 4, the information processing device 40 of this embodiment may include: a sending module 41.

The sending module 41 is configured to send an operation message to a game server, where the operation message carries location information corresponding to a starting point and an ending point of an attack operation, and the attack operation is triggered by the first client, the location information corresponding to the starting point and the ending point of the attack operation being sent to at least one second client by the game server, to cause the at least one second client to determine whether there is an obstacle between the starting point and the ending point of the attack operation and send a determination result to the game server, so that the game server decides according to the determination result whether the first client uses a hacking tool when performing the attack operation, where the first client and the second client are participating in a same game round.

Optionally; the information processing device 40 may further include: a receiving module 42. The receiving module 42 may be configured to receive a decision result of whether the first client uses the hacking tool sent by the game server.

If it is decided that the first client has used the hacking tool, the sending module 41 may also be configured to send information that the hacking tool has been used to an operation server.

The information processing device described in this embodiment may be used to perform the technical solution performed by the first client in each of the corresponding method embodiments. The implementation principles and technical effects are similar, and for the functions of the individual modules, reference can be made to the corresponding descriptions in the method embodiments, which will not be repeated here.

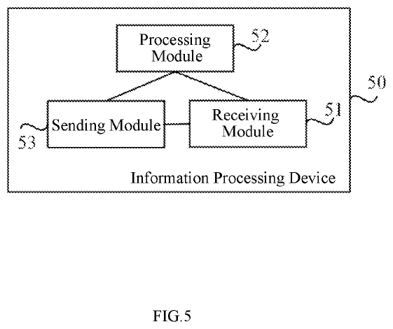

FIG. 5 is a schematic structural diagram of an information processing device according to another embodiment of the present disclosure. The embodiments of the present disclosure provide an information processing device, which is applied to a second client. As shown in FIG. 5, the information processing device 50 of this embodiment may include: a receiving module 51, a processing module 52 and a sending module 53.

The receiving module 51 is configured to receive location information corresponding to a starting point and an ending point of an attack operation sent by a game server, where the location information corresponding to the starting point and the ending point of the attack operation is sent to the game server by a first client, and the first client and the second client are participating in a same game round.

The processing module 52 is configured to determine whether there is an obstacle between the starting point and the ending point of the attack operation according to the location information corresponding to the starting point and the ending point of the attack operation.

The sending module 53 is configured to send a determination result to the game server, so that the game server decides whether the first client uses a hacking tool when performing the attack operation according to the determination result.

The information processing device described in this embodiment may be used to perform the technical solution performed by the second client in each of the corresponding method embodiments. The implementation principles and technical effects are similar, and for the functions of the individual modules, reference can be made to the corresponding descriptions in the method embodiments, which will not be repeated here.

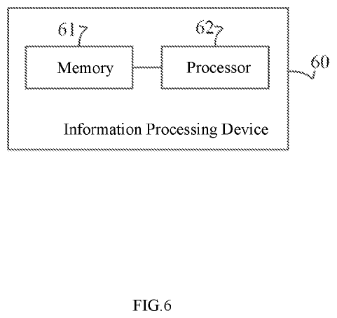

FIG. 6 is a schematic structural diagram of an information processing device according to another embodiment of the present disclosure. As shown in FIG. 6, the information processing device 60 of this embodiment includes a memory 61 and a processor 62, and the memory 61 and the processor 62 are connected to each other.

The memory 61 is configured to store program instructions.

When the program instructions stored in the memory 61 are executed by the processor 62, the information processing device 60 is caused to perform the method as described in any of the above embodiments.

Exemplarily, the information processing device 60 may be the game server or the client. Illustratively, the client is, for example, a device that can run a game, such as a mobile phone or a tablet. The game server may be a server, or a server cluster composed of several servers, or a cloud computing service center, and so on.

The embodiments of the present disclosure also provide a computer-readable storage medium having stored thereon a computer program which can be executed by a processor to implement the method shown in any of the above embodiments. For specific implementation and effective effects thereof, reference can be made to the above description, which will not be described in detail here.

Those of ordinary skill in the art can understand that all or part of the steps of the foregoing method embodiments may be completed by hardware related to program instructions. The aforementioned computer program may be stored in a computer-readable storage medium. When the program is executed, the steps including the above method embodiments are executed; and the foregoing storage medium includes: a read-only memory (ROM), a random access memory (RAM), a disk, or various media such as an optical disc that can store program codes.

Finally, it should be noted that the above embodiments are only used to illustrate the technical solutions of the present disclosure, but not to limit them; although the present disclosure has been described in detail with reference to the foregoing embodiments, those of ordinary skill in the art should understand that they can still modify the technical solutions described in the foregoing embodiments, or equivalently replace some or all of the technical features; and these modifications or replacements do not make the essence of the corresponding technical solutions to deviate from the scope of the technical solutions of the embodiments of the present disclosure.

What is claimed is:

1. An information processing method, comprising:
receiving, by a game server, an operation message sent by a first client, wherein the operation message comprises location information corresponding to a starting point and an ending point of an attack operation, and the attack operation is triggered by the first client;
sending, by the game server, the location information corresponding to the starting point and the ending point of the attack operation to at least one second client, wherein the first client and the second client are participating in a same game round;
receiving, by the game server, a determination result of whether there is an obstacle between the starting point and the ending point of the attack operation sent by the at least one second client, wherein the determination result is generated by the at least one second client based on the location information corresponding to the starting point and the ending point of the attack operation; and
deciding, by the game server according to the determination result, whether the first client uses a hacking tool when performing the attack operation.

2. The method according to claim 1, wherein the method further comprises:
sending, by the game server, a decision result of whether the first client uses the hacking tool to the first client, wherein in a case where it is decided that the first client uses the hacking tool, information that the hacking tool is used is sent to an operation server by the first client.

3. The method according to claim 1, wherein the deciding, by the game server according to the determination result, whether the first client uses a hacking tool when performing the attack operation comprises:
counting, by the game server, a number of second clients that have sent the determination result that there is the obstacle between the starting point and the ending point of the attack operation, and deciding that the first client uses the hacking tool when performing the attack operation if the number of the second clients is greater than or equal to a threshold: otherwise, deciding that the first client does not use the hacking tool when performing the attack operation.

4. The method according to claim 1, wherein the deciding, by the game server according to the determination result, whether the first client uses a hacking tool when performing the
counting, by the game server, the determination result sent by the at least one second client, and deciding whether the first client uses the hacking tool when performing the attack operation according to a counting result.

5. The method according to claim 1, wherein the determination result is generated by performing simulation calculation based on the location information corresponding to the starting point and the ending point of the attack operation by the at least one second client to determine whether there is the obstacle between the starting point and the ending point of the attack operation.

6. The method according to claim 5, wherein location information corresponding to the starting point and the ending point of the attack operation represents three-dimensional (3D) coordinate values of a position where the attack operation is performed in a 3D game scene and 3D coordinate values of a position that is attacked on a virtual character in the 3D game scene.

7. The method according to claim 1, wherein the receiving, by the game server, the determination result of whether there is the obstacle between the starting point and the ending point of the attack operation sent by the at least one second client comprises:
receiving, by the game server, the determination result that is sent by the at least one second client only when it is determined that there is the obstacle between the starting point and the ending point of the attack operation.

8. The method according to claim 1, wherein one determination result is generated by one second client, and the deciding, by the game server according to the determination result, whether the first client uses the hacking tool when performing the attack operation comprises:
deciding, by the game server according to at least one determination result, whether the first client uses the hacking tool when performing the attack operation.

9. The method according to claim 8, further comprising:
incrementing an error counter by one each time the game server receives one determination result, wherein the error counter has an initial value of 0 and is used for counting the number of the second clients that send the determination result.

10. An information processing method, comprising:
sending, by a first client, an operation message to a game server, wherein the operation message comprises location information corresponding to a starting point and an ending point of an attack operation, and the attack operation is triggered by the first client, the location information corresponding to the starting point and the ending point of the attack operation being sent to at least one second client by the game server, to cause the at least one second client to determine whether there is an obstacle between the starting point and the ending point of the attack operation and send a determination result to the game server, to cause the game server to decide, according to the determination result, whether the first client uses a hacking tool when performing the attack operation, wherein the first client and the second client are participating in a same game round.

11. The method according to claim 10, wherein after sending, by the first client, the operation message to the game server, the method further comprises:
receiving, by the first client, a decision result of whether the first client uses the hacking tool sent from the game server; and
in a case where it is decided that the first client uses the hacking tool, sending, by the first client, information that the hacking tool is used to an operation server.

12. The method according to claim 10, wherein the determination result is generated by performing simulation calculation based on the location information corresponding to the starting point and the ending point of the attack operation by the at least one second client to determine whether there is the obstacle between the starting point and the ending point of the attack operation.

13. The method according to claim 12, wherein location information corresponding to the starting point and the ending point of the attack operation represents three-dimensional (3D) coordinate values of a position where the attack operation is performed in a 3D game scene and 3D coordinate values of a position that is attacked on a virtual character in the 3D game scene.

14. An information processing method, comprising:
receiving, by a second client, location information corresponding to a starting point and an ending point of an attack operation sent by a game server, wherein the location information corresponding to the starting point and the ending point of the attack operation is sent to the game server by a first client, and the first client and the second client are participating in a same game round;
determining, by the second client, whether there is an obstacle between the starting point and the ending point of the attack operation according to the location information corresponding to the starting point and the ending point of the attack operation; and
sending, by the second client, a determination result to the game server, to cause the game server to decide, according to the determination result, whether the first client uses a hacking tool when performing the attack operation.

15. The method according to claim 14, wherein the determining, by the second client, whether there is the obstacle between the starting point and the ending point of the attack operation according to the location information corresponding to the starting point and the ending point of the attack operation comprises:
determining whether there is the obstacle between the starting point and the ending point of the attack operation by performing simulation calculation based on the location information corresponding to the starting point and the ending point of the attack operation by the at least one second client.

16. The method according to claim 15, wherein location information corresponding to the starting point and the ending point of the attack operation represents three-dimensional (3D) coordinate values of a position where the attack operation is performed in a 3D game scene and 3D coordinate values of a position that is attacked on a virtual character in the 3D game scene.

17. The method according to claim 14, wherein the sending, by the second client, the determination result to the game server comprises:
sending, by the second client, the determination result to the game server only if it is determined that there is the obstacle between the starting point and the ending point of the attack operation, otherwise not sending the determination result to the game server.

18. The method according to claim 14, wherein there is at least one second client, one determination result is generated by one second client, and the sending, by the second client, the determination result to the game server, to cause the game server to decide, according to the determination result, whether the first client uses the hacking tool when performing the
sending, by at least one second client, at least one determination result to the game server, to cause the game server to decide, according to the at least one determination result, whether the first client uses the hacking tool when performing the attack operation.

19. The method according to claim 18, further comprising:
incrementing an error counter by one each time one second client sends one determination result to the game server, wherein the error counter has an initial value of 0 and is used for counting the number of the second clients that send the determination result.
